(19) United States
(12) Patent Application Publication
(10) Pub. No.: US 2010/0295847 A1
(43) Pub. Date: Nov. 25, 2010

(54) DIFFERENTIAL MODEL ANALYSIS WITHIN A VIRTUAL WORLD

(75) Inventor: Tobin Titus, East Liverpool, OH (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/469,686

(22) Filed: May 21, 2009

(51) Int. Cl. G06T 17/40

(52) U.S. Cl. 345/419

(57) ABSTRACT

A current three-dimensional model of a real world item is received. A last three-dimensional model of the real world item is also received. Differences between the current three-dimensional model and the last three-dimensional model are determined. A determination is made as to whether the differences fall above or below a threshold indicating a minimum acceptable condition of the real world item. If the differences fall above or below the threshold indicating the minimum acceptable condition of the real world item, then the virtual world is transformed from a previous state where the virtual world does not include the current three-dimensional model and the last three-dimensional model into another state where the virtual world includes the current three-dimensional model and the last three-dimensional model. The virtual world is provided across a network. The current three-dimensional model and the last three-dimensional model may be remotely viewed through the virtual world.

### BACKGROUND

In recent years, massively multiplayer online (“MMO”) computer applications, such as massively multiplayer online role-playing games (“MMORPGs”), have become extremely popular not only with serious gamers, but also with casual gamers and other Internet users. One example of a MMO computer application enables a participant to create and develop a fictional character in a virtual world. The fictional character is usually associated with an avatar or some other visual representation that enables other participants to recognize the particular fictional character. A given participant may develop, among other things, a storyline, a reputation, and attributes of her fictional character by interacting in the virtual world via the fictional character. Other examples of MMO computer applications may not involve the creation of a virtual world representation of the participant.

The virtual world typically includes an environment with a variety of virtual locations containing a variety of virtual objects. In some cases, the virtual locations and the virtual objects mimic realistic locations and objects, while in other cases, the virtual locations and virtual objects are fanciful creations. MMO computer applications generally permit the fictional character to travel across the virtual locations and interact with the virtual objects and other fictional characters.

Participants generally immerse themselves into the virtual world without much consideration of its impact or relevance, if any, to the real world. Similarly, participants generally immerse themselves into the real world without much consideration of its impact or relevance, if any, to the virtual world. The lack of connection between the real world and the virtual world is sometimes due to the lack of interactivity between the two. Even when a virtual world bears some connection to the real world, this connection tends to provide only a limited social function (e.g., sharing your current status with other participants). In this regard, the interaction between the real world and the virtual world outside of basic social applications has not been explored.

It is with respect to these and other considerations that the disclosure made herein is presented.

### SUMMARY

Technologies are described herein for providing differential model analysis within a virtual world. A real world item may be visually represented by a virtual three-dimensional (“3D”) model that is generated through a 3D scanner or other suitable device. Each real world item may be associated with a timeline that includes one or more 3D models previously generated across a period of time. As used herein, the term “differential model analysis” refers to an analysis of the differences between a current 3D model of a real world item and a last 3D model of the real world item.

The current 3D model may be generated when a differential model analysis is requested. When a differential model analysis is requested, a 3D scanner may project a light or laser toward the real world item and collect visual data as a result of the light or laser being projected toward the real world item. The current 3D model may then be generated based on the visual data. The last 3D model may be the most recent 3D model that was generated prior to the differential model analysis being requested. The timeline may indicate the last 3D model. It should be appreciated that laser and light scanners are merely one illustrative way to create a 3D model. In other embodiments, other suitable equipment and approaches may be similarly utilized, as contemplated by those skilled in the art. For example, the visual data of the real world item may be collected via a multi-angled camera.

The current 3D model may be compared with the last 3D model to determine any differences. The differences may then be compared against a threshold indicating a minimum acceptable condition of the real world item. These differences may include differences in shape, surface texture, color, and the like. It is noted that visual data collected via a conventional light or laser scanner may not contain color information. However, visual data collected through a camera, such as the multi-angled camera described above, may contain color information. If the differences exceed the threshold, then the current 3D model is inserted into the timeline, and the current 3D model becomes the last 3D model. If the differences fall above or below the threshold, then the virtual world is transformed from a previous state where the virtual does not include the current 3D model and the last model into another state where the virtual world includes the current 3D model and the last 3D model. In this way, the differences between the current 3D model and the last 3D model may be manually inspected. If the differences fall above or below the threshold, then one or more events may also be triggered.

According to one embodiment, a method is provided herein for providing differential model analysis within a virtual world. A current three-dimensional model of a real world item is received. A last three-dimensional model of the real world item is also received. Differences between the current three-dimensional model and the last three-dimensional model are determined. A determination is made as to whether the differences fall above or below a threshold indicating a minimum acceptable condition of the real world item. If the differences fall above or below the threshold indicating the minimum acceptable condition of the real world item, then the virtual world is transformed from a previous state where the virtual world does not include the current three-dimensional model and the last three-dimensional model into a another state where the virtual world includes the current three-dimensional model and the last three-dimensional model. The virtual world is provided across a network. The current three-dimensional model and the last three-dimensional model may be remotely viewed through the virtual world.

It should be appreciated that although the features presented herein are described in the context of a MMO computer application, these features may be utilized with any type of virtual world or environment including, but not limited to, other types of games as well as online social communities. It should also be appreciated that the above-described subject matter may also be implemented as a computer-controlled apparatus, a computer process, a computing system, or as an article of manufacture such as a computer-storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all of the disadvantages noted in any part of this disclosure.

### BRIEF DESCRIPTION OF THE DRAWINGS

FIG. 1 is a network architecture diagram showing aspects of a network architecture capable of implementing a virtual world, in accordance with embodiments;

FIG. 2 is a block diagram showing a system operative to scan a real world item and to generate a virtual 3D model of the real world item, in accordance with embodiments;

FIG. 3 is a diagram showing a timeline displaying previously-generated 3D models of a real world item, in accordance with embodiments;

FIG. 4 is a flow diagram illustrating a method for generating 3D models, in accordance with embodiments;

FIG. 5 is a flow diagram illustrating a method for providing differential model analysis within a virtual world, in accordance with embodiments; and

FIG. 6 is a computer architecture diagram showing aspects of an illustrative computer hardware architecture for a computing system capable of implementing aspects of the embodiments presented herein.

### DETAILED DESCRIPTION

The following detailed description is directed to technologies for providing differential model analysis within a virtual world. Through the utilization of the technologies and concepts presented herein, virtual 3D models of a real world item may be generated over a period of time. The current condition of the real world item may be determined by comparing a current 3D model with the last 3D model that was generated. If the differences indicate that the condition of the real world item has changed beyond a given threshold, then the current 3D model and the last 3D model may be included within the virtual world.

By including the current 3D model and the last 3D model in the virtual world for viewing, a user accessing the virtual world can visually compare the current 3D model and the last 3D model in order to manually assess the level of damage, if any, to the corresponding real world item. That is, through the 3D models, the user can remotely determine the condition of the real world item without having the real world item present. As used herein, the term “3D model” refers to computer-generated, virtual 3D models, which can be contrasted from real world items.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

As used herein, the term virtual world refers to a computer-implemented environment, which may include simulated, lifelike environments as well as fanciful, non-existing environments. Examples of virtual worlds may include any massively multiplayer online (“MMO”) computer application including, but not limited to, massively multiplayer online role-playing games (“MMORPGs”), virtual social communities, and virtual reality computer applications. In one embodiment, the MMO computer application simulates a real world environment. For example, the virtual world may be defined by a number of rules, such as the presence of gravity or the lack thereof. In other embodiments, the MMO computer application includes a fanciful environment that does not simulate a real world environment.

The virtual world may be inhabited by avatars, which are virtual or symbolic representations of real world participants (hereinafter referred to as participants). As such, each avatar is typically associated with and controlled by a particular participant. Avatars may include two-dimensional and/or three-dimensional images. Through the virtual world, the avatars may interact with other avatars, as well as with virtual objects. Virtual objects may include virtual representations of real world objects, such as houses, cars, billboards, clothes, packages, and soda cans, as well as fanciful creations, such as a teleportation machine or a flying car. The avatars and the virtual objects utilized in the virtual world may or may not be animated images.

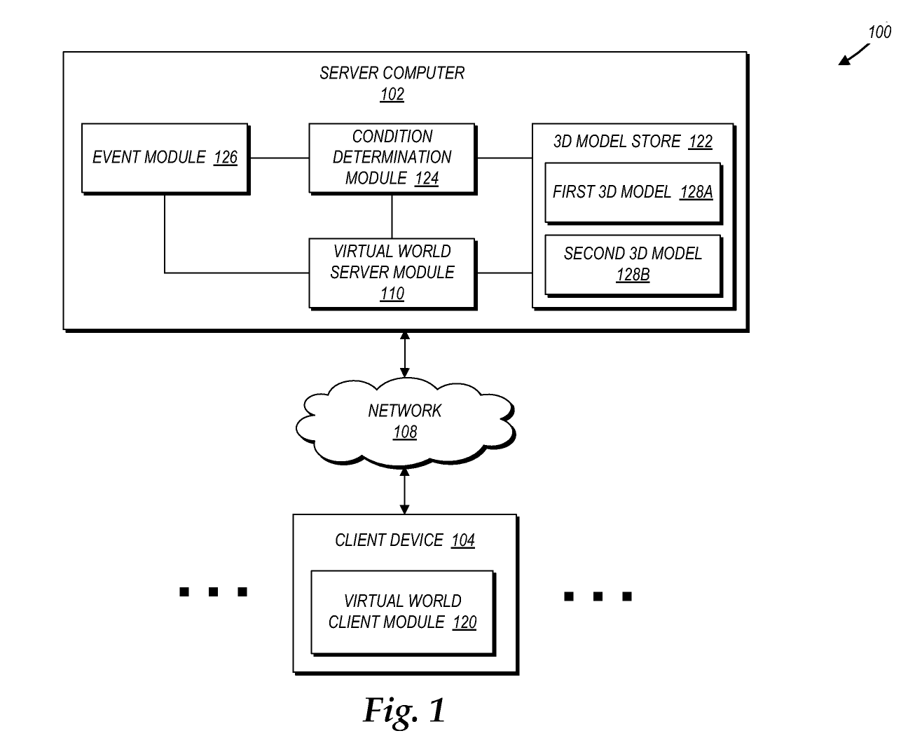

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for implementing a virtual world will be described. In particular, FIG. 1 illustrates a simplified network architecture 100 for implementing a virtual world. The network architecture 100 shown in FIG. 1 includes a server computer 102 and a client device 104, each of which is operatively coupled via a network 108. The network 108 may be any suitable network, such as a local area network (“LAN”) or the Internet. Although only one client device 104 is illustrated in FIG. 1, the network architecture 100 may include multiple client devices and multiple computing devices in any suitable network configuration.

The client device 104 may be any suitable processor-based device, such as a computer or a gaming device. Exemplary gaming devices include the XBOX and the XBOX 360 from MICROSOFT CORPORATION, the WII from NINTENDO COMPANY, LIMITED, and the PLAYSTATION 3 and the PSP from SONY CORPORATION. Although not so illustrated in FIG. 1, the client device 104 may be coupled to any suitable peripheral devices to enable the participant to experience and interact with the virtual world. Example peripheral devices may include an input device, such as a keyboard, a mouse, a microphone, and a game controller, and an output device, such as a display and speakers. Some peripheral devices may even provide both input and output functionality. For example, a game controller may provide vibration feedback.

As shown in FIG. 1, the client device 104 includes a virtual world client module 120, which interacts with a virtual world server module 110 executing on the server computer 102. In particular, the virtual world client module 120 may receive and process data from the virtual world server module 110 and output the data to output devices coupled to the client device 104. Further, the virtual world client module 120 may receive data from input devices coupled to the client device 104 and transmit the data to the virtual world server module 110.

The virtual world client module 120 may include any suitable component for accessing the virtual world server module 110. In one example, the virtual world client module 120 may be a computer application configured to locally provide at least a portion of the virtual world for the client device 104. In this way, the amount of data retrieved from the server computer 102 by the client device 104 to generate the virtual world may be reduced. In another example, the virtual world client module 120 may be a web browser configured to retrieve the virtual world from the virtual world server module 110. Since many public computers, such as those found in Internet cafes, commonly have a web browser installed and prohibit the installation of new computer applications, providing participants a way to access the virtual world via the web browser may provide greater accessibility and convenience.

As shown in FIG. 1, the server computer 102 includes the virtual world server module 110, a 3D model store 122, a condition determination module 124, and an event module 126. The virtual world server module 110 generally administers the virtual world and serves as a conduit between multiple client devices, including the client device 104. The 3D model store 122 generally stores 3D models, such as a first 3D model 128A and a second 3D model 128B (collectively referred to as 3D models 128). The condition determination module 124 generally determines the condition of particular real world item by analyzing 3D models corresponding to the real world item. The event module 126 generally controls real world events based on the condition of the real world item as determined by the condition determination module 124.

According to embodiments, the 3D models 128 are virtual world models that are capable of being implemented within the virtual world generated by the virtual world server module 110. Each 3D model may provide a digital and visual representation of a real world item. In this way, a person can view the real world item through its 3D models without necessarily having the real world item physically present. As used herein, an “item” may refer to an inanimate object or a living being.

The 3D model store 122 may receive the 3D models 128 from another computer or device (not shown in FIG. 1) over the network 108. In one embodiment, the 3D model store 122 receives the 3D models 128 at regular intervals over a period of time. For example, a remote scanning device may scan the real world item at certain times, generate a 3D model based on the scanned data, and store the 3D model in the 3D model store 122. In other embodiments, the 3D model may be generated on the server computer 102 instead of at the remote scanning device. The virtual world server module 110 may retrieve the 3D models 128 from the 3D model store 122 and implement the 3D models 128 within the virtual world. For example, the virtual world may include an application that is operative to display the 3D models 128 within the virtual world.

According to embodiments, the condition determination module 124 may determine the condition of a real world item by analyzing the 3D models 128 corresponding to the real world item. Once the 3D models 128 are generated, the 3D models 128 may be included within a timeline that charts when each of the 3D models 128 was generated. The condition of the real world item may be determined by comparing a current 3D model with the last 3D model that was generated as indicated by the timeline. Because the timeline provides a history of the condition of the real world item, the condition of the real world item at any point along the timeline may also be reviewed and reanalyzed as necessary.

In an illustrative example, the 3D models 128 may be 3D models of a package in transit for delivery. In other examples, the 3D models 128 may be 3D models of a flowers or pizza in transit for delivery, an airplane while it is in flight, or a user playing a video game. In the case of the user playing the video game, the corresponding 3D model may be an avatar in virtual world.

In the case of a package in transit for delivery, the first 3D model 128A may be a 3D model of the package based on data obtained at a time T along a timeline when the package is picked up for delivery. The second 3D model 128B may be a 3D model of the package based on data obtained at a time T+X along the timeline, which is after the time T. In order to determine the condition of the package at a time T+X, the condition determination module 124 may compare the second 3D model 128B with the first 3D model 128A. In particular, the condition determination module 124 may compare and analyze any appearance characteristics, such as the shape, surface texture, color, of the virtual item represented by the 3D models 128. The condition determination module 124 may then determine a condition of the package at time T+X based on the analysis of the appearance 3D models 128.

According to embodiments, if the condition of the real world item, as determined by the condition determination module 124 by comparing the 3D models 128, falls above or below (or within) a minimum acceptable condition (e.g., exceeds a minimum acceptable damage), then the virtual world is transformed from a previously state where the virtual world does not include the second 3D model 128B and the first 3D model 128A into another state where the virtual world includes the second 3D model 128B and the first 3D model 128A. Further, if the condition of the real world item falls above or below the minimum acceptable condition, one or more events may also be triggered. In particular, the condition determination module 124 may instruct the event module 126 to perform certain events. For example, the event module 126 may initiate a manual inspection of a package in transit that has been determined to be damaged.

The event module 126 may notify the shipper, the recipient, or a third party of the possible damage to the package and provide instructions for remotely viewing the 3D models 128 through the virtual world. In this way, the shipper, the recipient, or the third party can inspect the condition of the package without having the package physically present. The shipper, recipient, or third party may be notified through the virtual world or separate from the virtual world. For example, the shipper, recipient, or third party may be notified via short messaging service (“SMS”) of damage to the package (e.g., “Minor damage is found on the left bottom corner of your package outside of normal conditions). In this example, the inspection of the package may occur separate from the event notification.

Although the embodiments described herein primarily refer to the degradation of the real world item with respect to the virtual world item, it should be appreciated that the embodiments may be similarly applied to situations desiring the improvement of the real world item with respect to the virtual world item. For example, a virtual world item may be initially created. Then a real world item (e.g., a prototype) may be created, adjusted, and remodeled until the corresponding 3D model falls within an acceptable differential range (i.e., a minimum acceptable quality) with respect to the virtual world item.

When a participant desires to access the virtual world, the participant may initiate the virtual world client module 120 to establish a session with the virtual world server module 110 via the network 108. During the session, the virtual world server module 110 may transmit data (e.g., environment layouts, avatar movements of other participants, 3D models) associated with the virtual world to the virtual world client module 120. Similarly, the virtual world client module 120 may transmit data from associated input devices to the virtual world server module 110.

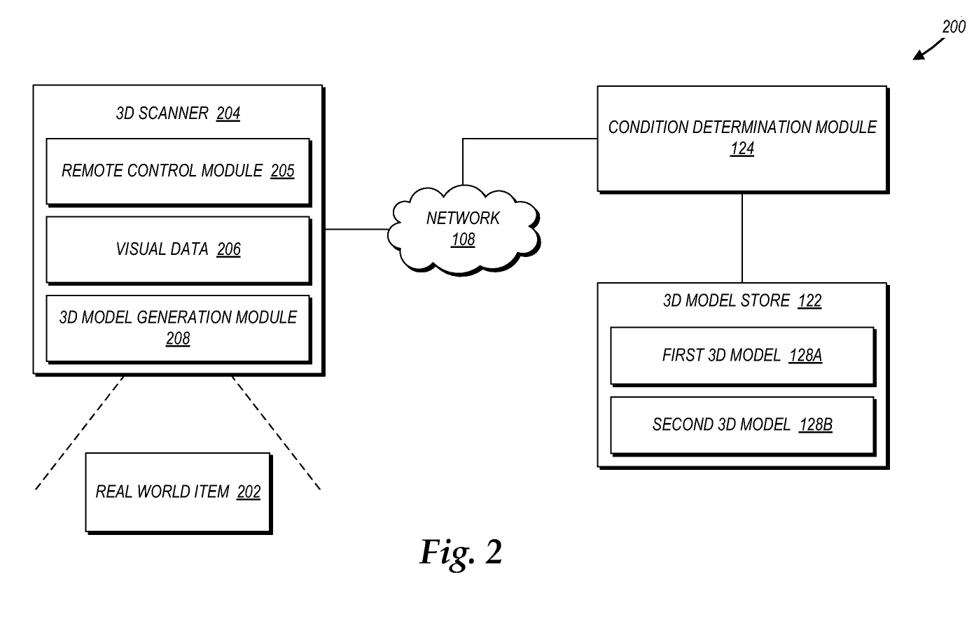

Referring now to FIG. 2, a block diagram showing an illustrative system 200 for scanning a real world item 202 and generating the 3D models 128 based on the visual data collected by scanning the real world item 202. As illustrated in FIG. 2, the system includes a 3D scanner 204, which is operative to scan the real world item 202. In some embodiments, the 3D scanner 204 is a laser or light 3D scanner. The 3D scanner may project laser or light toward the real world item 202. Examples of 3D scanners include the SOLUTIONIX ARX300 and SOLUTIONIX ARX600. A 3D model generation module 208 then collects visual data 206 that results from the projected laser or light.

Upon collecting the visual data 206 regarding the real world item 202, the 3D model generation module 208 generates a 3D model, such as the first 3D model 128A. The 3D model generation module 208 then transmits, over the network 108, the first 3D model 128A to the server computer 102 to be stored in the 3D model store 122. The 3D model generation module 208 can then collect additional visual data at a later time, and generate additional 3D models, such as the second 3D model 128B. In some embodiments, the 3D model generation module 208 generates 3D models at predefined intervals in an automated manner. In other embodiments, the 3D model generation module 208 may be manually controlled. For example, the 3D model generation module 208 may be manually controlled across the network 108 utilizing a remote control module 205.

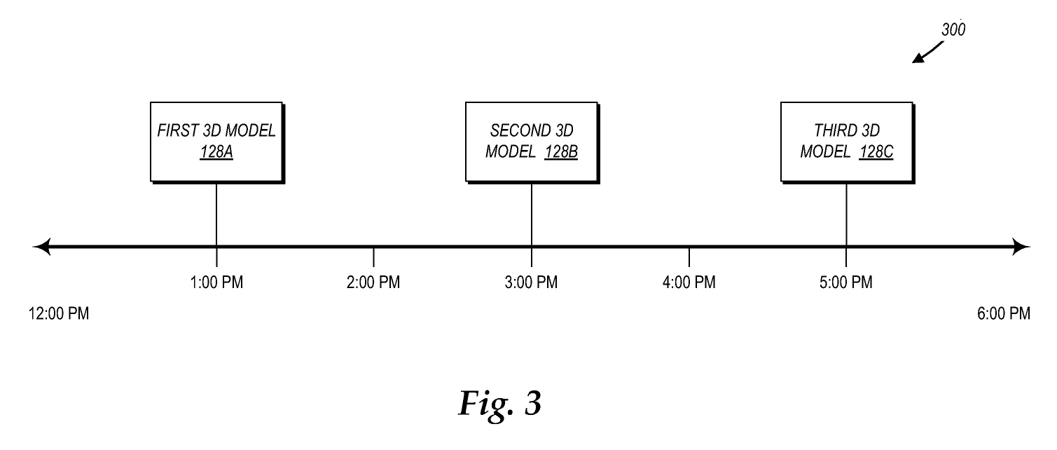

Referring now to FIG. 3, a diagram showing a timeline 300 between 12 PM and 6 PM in which the 3D model generation module 208 has generated three virtual world models 128, including the first 3D model 128A, the second 3D model 128B, and a third 3D model 128C. In one embodiment, the 3D models in any given timeline are associated with a single real world item. As illustrated in FIG. 3, the 3D model generation module 208 collects the visual data 206 and generates the first 3D model 128A at 1 PM. The 3D model generation module 208 then collects the visual data 206 and generates the second 3D model 128B at 3 PM. Further, the 3D model generation module 208 collects the visual data 206 and generates the third 3D model 128C at 5 PM. In this case, the 3D model generation module 208 may be configured to collect the visual data 206 and to generate the corresponding 3D model at intervals of two hours.

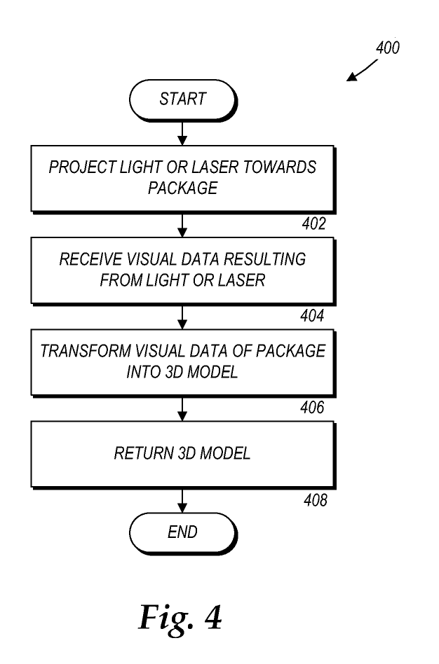

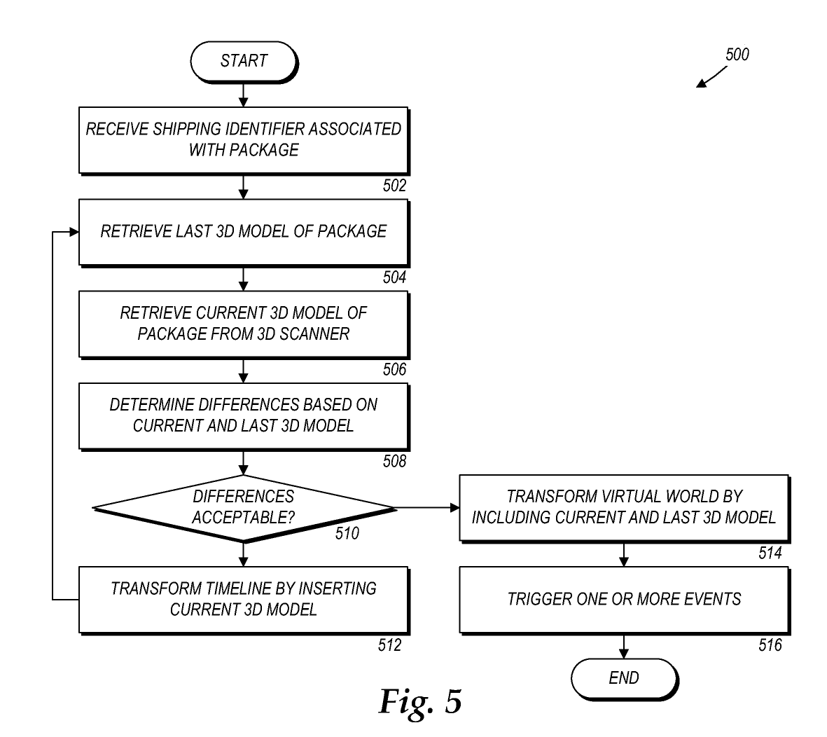

Referring now to FIGS. 4-5, additional details will be provided regarding the embodiments presented herein for providing differential model analysis in a timeline within a virtual world. In particular, FIG. 4 is a flow diagram illustrating a method for generating the 3D models 128. FIG. 5 is a flow diagram illustrating a method for providing differential model analysis within a virtual world.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

In FIG. 4, a routine 400 begins at operation 402, where the 3D model generation module 208 receives the visual data 206 after the 3D scanner 204 projects a light or laser towards the real world item 202. Although the embodiments are not so limited, for the sake of illustration, the real world item 202 is described in this example as a package in transit. The routine 402 proceeds to operation 404, where the 3D scanner 204 receives visual data 206 resulting from the projected light or laser. Upon receiving the visual data 206 of the package, the routine 400 proceeds to operation 406.

At operation 406, the 3D model generation module 208 transforms the visual data 206 collected by the 3D scanner 204 into a 3D model, such as the first 3D model 128A or the second 3D model 128B. Once the 3D model generation module 208 transforms the visual data 206 into the 3D model, the routine 400 proceeds to operation 408, where the 3D scanner 204 returns the 3D model.

In FIG. 5, a routine 500 begins at operation 502, where the condition determination module 124 receives a shipping identifier associated with a package. The shipping identifier may be an alphanumeric string that identifies the package for tracking purposes. In this example, the shipping identifier may be provided by the courier company in order to track the condition of the package. However, in other embodiments, the shipping identifier may be provided by a participant of the virtual world. According to embodiments, the shipping identifier may be utilized to retrieve the 3D models 128 from the 3D model store 122. Once the condition determination module 124 receives the shipping identifier, the routine 500 proceeds to operation 504.

At operation 504, the condition determination module 124 retrieves the last 3D model of the package identified by the shipping identifier. The condition determination module 124 may query the 3D model store 122 by requesting the last 3D model that was generated along the timeline 300. For example, with reference to FIG. 3, if the current time is 3:00 PM, then the last 3D model is the first 3D model 128A. In this example, the 3D model store 122, in response to the query from the condition determination module 124, transmits the first 3D model 128A to the condition determination module 124. Once the condition determination module 124 retrieves the last 3D model, the routine 500 proceeds to operation 506.

At operation 506, the condition determination module 124 retrieves the current 3D model of the package identified by the shipping identifier. The condition determination module 124 may control the 3D scanner 204 through the remote control module 205 across the network 108. In particular, the condition determination module 124 may instruct the 3D model generation module 208 to scan the real world item 202 in order to collect the visual data 206. Upon collecting the visual data 206, the 3D model generation module 208 generates the 3D model. For example, with reference to FIG. 3, if the current time is 3:00 PM, then the current 3D model is the second 3D model 128B. The 3D model generation module 208 then transmits the second 3D model 128B to the condition determination module 124 through the remote control module 205 across the network 108. Once the condition determination module 124 retrieves the current 3D model, the routine 500 proceeds to operations 508 and 510.

In operations 508 and 510, the condition determination module 124 determines the condition of the package identified by the shipping identifier. At operation 508, the condition determination module 124 compares the current 3D model with the last 3D model in order to determine any differences between the two models. In the example where the last 3D model is the first 3D model 128A and the current 3D model is the second 3D model 128B, the condition determination module 124 may compare the second 3D model 128B with the first 3D model 128A. The determined differences may include differences in shape, surface texture, color, and the like. Upon determining the differences of between the current 3D model and the last 3D model, the routine 508 proceeds to operation 510.

At operation 510, the condition determination module 124 determines whether the differences are acceptable with regards to the condition of the package. For example, the differences may be compared to a threshold indicating an acceptable condition of the package. In this case, if the differences fall above or below the threshold, then the differences are considered unacceptable, and if the differences exceed the threshold, then the differences are considered acceptable. If the condition determination module 214 determines that the differences are acceptable, then the routine 500 proceeds to operation 512.

At operation 512, the virtual world server module 110 inserts the current 3D virtual model into the timeline 300. For example, with reference to FIG. 3, the virtual world server module 110 may insert the second 3D model 128B at the 3:00 PM time on the timeline. Once the virtual world server module 110 inserts the current 3D model into the timeline 300, the current 3D model becomes the last 3D model, and the routine 500 proceeds back to operation 504. In particular, operations 504, 506, 508, 510, and 512 may be repeated while the differences between the current 3D model and the last 3D model are determined to be acceptable at operation 510. According to embodiments, the routine 500 may proceed back to operation 504 at regular intervals.

If the condition determination module 214 determines that the differences are unacceptable, then the routine 500 proceeds to operation 514. At operation 514, the condition determination module 214 transforms, through the virtual world server module 110, the virtual world by including the current 3D model and the last 3D model in the virtual world. The routine 500 then proceeds to operation 516, where the condition determination module 214 triggers one or more events through the event module 126. Examples of events may include notifying a human agent to inspect the package, notifying the shipper of possible damage to the package, notifying the recipient of possible damage to the package, and requesting additional input for how to proceed. The notification of possible damage to the package may include instructions for remotely viewing the current 3D model and the last 3D model through the virtual world.

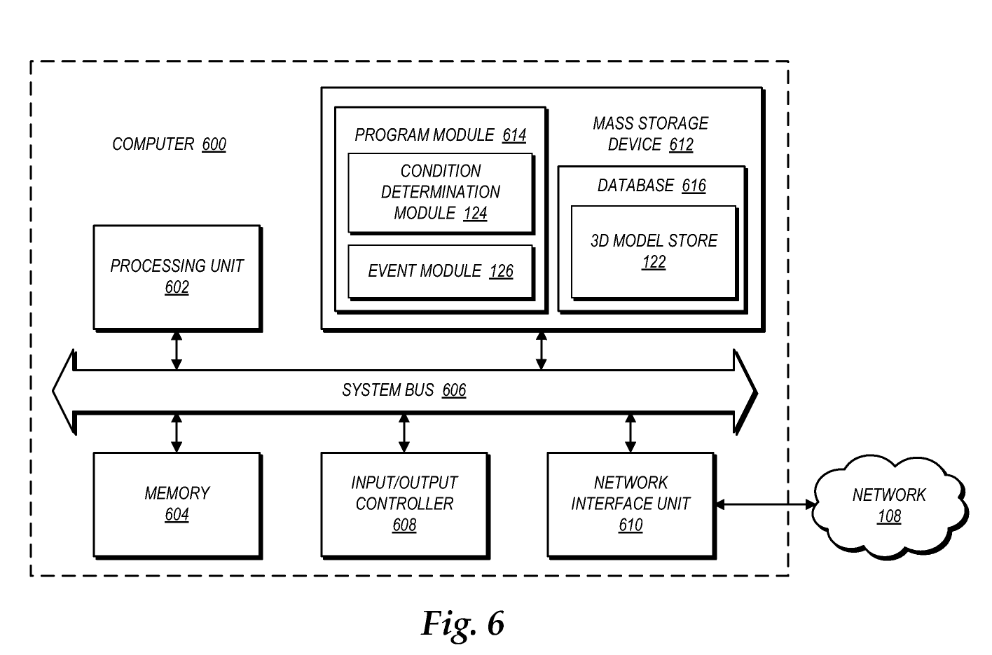

Referring now to FIG. 6, an exemplary computer architecture diagram showing aspects of a computer 600 is illustrated. Examples of the computer 600 may include the server computer 102 and the client device 104. The computer 600 includes a processing unit 602 (“CPU”), a system memory 604, and a system bus 606 that couples the memory 604 to the CPU 602. The computer 600 further includes a mass storage device 612 for storing one or more program modules 614 and one or more databases 616. Examples of the program modules 614 include the condition determination module 124 and the event module 126. An example of the databases 216 is the 3D model store 122. The mass storage device 612 is connected to the CPU 602 through a mass storage controller (not shown) connected to the bus 606. The mass storage device 612 and its associated computer-storage media provide non-volatile storage for the computer 600. Although the description of computer-storage media contained herein refers to a mass storage device, such as a hard disk or CD-ROM drive, it should be appreciated by those skilled in the art that computer-storage media can be any available computer storage media that can be accessed by the computer 600.

By way of example, and not limitation, computer-storage media may include volatile and non-volatile, removable and non-removable media implemented in any method or technology for storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 108. The computer 600 may connect to the network 108 through a network interface unit 610 connected to the bus 606. It should be appreciated that the network interface unit 610 may also be utilized to connect to other types of networks and remote computer systems. The computer 600 may also include an input/output controller 608 for receiving and processing input from a number of input devices (not shown), including a keyboard, a mouse, a microphone, and a game controller. Similarly, the input/output controller 608 may provide output to a display or other type of output device (not shown).

The bus 606 may enable the processing unit 602 to read code and/or data to/from the mass storage device 612 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 614 may include software instructions that, when loaded into the processing unit 602 and executed, cause the computer 600 to facilitate non-linguistic interaction with users via surface stimulation. The program modules 614 may also provide various tools or techniques by which the computer 600 may participate within the overall systems or operating environments using the components, flows, and data structures discussed throughout this description. For example, the program modules 614 may implement interfaces that facilitate non-linguistic interaction between the computer 600 and any number of users.

In general, the program modules 614 may, when loaded into the processors 106 and executed, transform the processing unit 602 and the overall computer 600 from a general-purpose computing system into a special-purpose computing system customized to facilitate non-linguistic interaction with computer systems via surface stimulation. The processing unit 602 may be constructed from any number of transistors or other discrete circuit elements, which may individually or collectively assume any number of states. More specifically, the processing unit 602 may operate as a finite-state machine, in response to executable instructions contained within the program modules 614. These computer-executable instructions may transform the processing unit 602 by specifying how the processing unit 602 transitions between states, thereby transforming the transistors or other discrete hardware elements constituting the processing unit 602.

Encoding the program modules 614 may also transform the physical structure of the computer-storage media. The specific transformation of physical structure may depend on various factors, in different implementations of this description. Examples of such factors may include, but are not limited to: the technology used to implement the computer-storage media, whether the computer-storage media are characterized as primary or secondary storage, and the like. For example, if the computer-storage media are implemented as semiconductor-based memory, the program modules 614 may transform the physical state of the semiconductor memory, when the software is encoded therein. For example, the program modules 614 may transform the state of transistors, capacitors, or other discrete circuit elements constituting the semiconductor memory.

As another example, the computer-storage media may be implemented using magnetic or optical technology. In such implementations, the program modules 614 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that technologies for providing differential model analysis within a virtual world are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing differential model analysis within a virtual world, the computer-implemented method comprising computer-implemented operations for:
receiving a current three-dimensional model of a real world item;
receiving a last three-dimensional model of the real world item;
determining differences between the current three-dimensional model and the last three-dimensional model;
determining whether the differences fall above or below a threshold indicating a minimum acceptable condition of the real world item;
upon determining that the differences fall above or below the threshold indicating the minimum acceptable condition of the real world item, transforming the virtual world from a previous state where the virtual does not include the current three-dimensional model and the last three-dimensional model into another state where the virtual world includes the current three-dimensional model and the last three-dimensional model; and
providing the virtual world across a network, the current three-dimensional model and the last three-dimensional model being remotely viewable through the virtual world.

2. The computer-implemented method of claim 1, wherein receiving a current three-dimensional model of a real world item comprises:
transmitting a command to a three-dimensional scanner to generate the current three-dimensional model of the real world item; and
upon transmitting the command to the three-dimensional scanner to generate the current three-dimensional model of the real world item, receiving the current three-dimensional model from the three-dimensional scanner.

3. The computer-implemented method of claim 2, wherein the three-dimensional scanner is operative to (i) project a light or laser towards the real world item, (ii) collect visual data resulting from the projected light or laser, and (iii) generate the current three-dimensional model based on the visual data.

4. The computer-implemented method of claim 1, wherein receiving a last three-dimensional model of the real world item comprises:
accessing a timeline containing one or more three-dimensional models including the last three-dimensional model; and
identifying the last three-dimensional model through the timeline, the last three-dimensional model being most recently generated.

5. The computer-implemented method of claim 4, further comprising computer-implemented operations for:
upon determining that the differences do not fall above or below the threshold indicating the minimum acceptable condition of the real world item, inserting the current three-dimensional model into the timeline.

6. The computer-implemented method of claim 1, wherein the differences comprises differences in shape, differences in color, or differences in surface texture.

7. The computer-implemented method of claim 1, further comprising computer-implemented operations for:
upon determining that the differences fall above or below the threshold indicating the minimum acceptable condition of the real world item, triggering one or more events.

8. The computer-implemented method of claim 7, wherein the events comprise transmitting a notification to manually evaluate the real world item.

9. The computer-implemented method of claim 8, wherein the notification comprises instructions for accessing the virtual world to remotely view the current three-dimensional model and the last three-dimensional model.

10. The computer-implemented method of claim 1, wherein the real world item comprises an object or a person.

11. The computer-implemented method of claim 1, wherein the minimum acceptable condition of the real world item comprises minimum acceptable damage of the real world item.

12. A computer system comprising:
a processor;
a memory operatively coupled to the processor; and
a program module (i) which executes in the processor from the memory and (ii) which, when executed by the processor, causes the computer system to provide differential model analysis within a virtual world by
receiving, from a three-dimensional scanner, a current three-dimensional model of a real world item,
identifying, through a timeline, a last three-dimensional model of the real world item,
retrieving, from a storage device, the last three-dimensional model of the real world item,
determining visual differences between the current three-dimensional model and the last three-dimensional model,
determining whether the differences fall above or below a threshold indicating a minimum acceptable condition of the real world item,
upon determining that the differences fall above or below the threshold indicating the minimum acceptable condition of the real world item, transforming the virtual world from a previous state where the virtual does not include the current three-dimensional model and the last three-dimensional model into another state where the virtual world includes the current three-dimensional model and the last three-dimensional model,
upon determining that the differences do not fall above or below the threshold indicating the minimum acceptable condition of the real world item, transforming the timeline by inserting the current three-dimensional model into the time, and
upon transforming the virtual world to include the current three-dimensional model and the last three-dimensional model, providing the virtual world across a network, the current three-dimensional model and the last three-dimensional model being remotely viewable through the virtual world.

13. The computer system of claim 12, wherein receiving, from a three-dimensional scanner, a current three-dimensional model of a real world item comprises:
transmitting, across the network, a command to the three-dimensional scanner to generate the current three-dimensional model of the real world item; and
upon transmitting the command to the three-dimensional scanner to generate the current three-dimensional model of the real world item, receiving the current three-dimensional model from the three-dimensional scanner, the three-dimensional scanner being operative to (i) project a light or laser towards the real world item, (ii) collect visual data resulting from the projected light or laser, and (iii) generate the current three-dimensional model based on the visual data.

14. The computer system of claim 12, wherein the last three-dimensional model is the most recently generated as indicated by the timeline.

15. The computer system of claim 12, wherein the visual differences comprises differences in shape, differences in color, or differences in surface texture.

16. The computer system of claim 12, the program module, when executed by the processor, further causing the computer system to provide differential model analysis within a virtual world by
upon determining that the differences fall above or below the threshold indicating the minimum acceptable condition of the real world item, triggering one or more events.

17. The computer system of claim 16, wherein the events comprise transmitting a notification to manually evaluate the real world item, the notification comprising instructions for accessing the virtual world to remotely view the current three-dimensional model and the last three-dimensional model.

18. The computer system of claim 12, wherein the real world item is in transit for delivery.

19. The computer system of claim 12, wherein the minimum acceptable condition of the real world item comprises minimum acceptable damage of the real world item.

20. A computer-storage medium having computer-executable instructions stored thereon which, when executed by a computer, cause the computer to:
transmit, across a network, a command to a three-dimensional scanner to generate a current three-dimensional model of a real world package while the real world package is in transit;
upon transmitting the command to the three-dimensional scanner to generate the current three-dimensional model of the real world package, receive, across the network, the current three-dimensional model from the three-dimensional scanner, the three-dimensional scanner being operative to (i) project a light or laser towards the real world package, (ii) collect visual data resulting from the projected light or laser, and (iii) generate the current three-dimensional model based on the visual data;
identify, through a timeline, a last three-dimensional model of the real world package, the last three-dimensional model being the most recently generated as indicated by the timeline;
retrieve, from a storage device, the last three-dimensional model of the real world package;
determine, through the computer, visual differences between the current three-dimensional model and the last three-dimensional model;
determine, through the computer, whether the differences fall above or below a threshold indicating a minimum acceptable condition of the real world package;
upon determining that the differences fall above or below the threshold indicating the minimum acceptable condition of the real world package, transform a virtual world from a previous state where the virtual does not include the current three-dimensional model and the last three-dimensional model into another state where the virtual world includes the current three-dimensional model and the last three-dimensional model;
upon determining that the differences do not fall above or below the threshold indicating the minimum acceptable condition of the real world package, transform the timeline by inserting the current three-dimensional model into the timeline; and
upon transforming the virtual world to include the current three-dimensional model and the last three-dimensional model, provide the virtual world across the network, the current three-dimensional model and the last three-dimensional model being remotely viewable through the virtual world.
